(19) United States
(12) Patent Application Publication
(10) Pub. No.: US 2008/0046824 A1
(43) Pub. Date: Feb. 21, 2008

(54) SORTING CONTACTS FOR A MOBILE COMPUTER DEVICE

(75) Inventors: John L. Li, Kirkland, WA (US); Naoaki Nii, Tokyo (JP); Audrey Yung Ch'In Tang, Seattle, WA (US); Rupali Jain, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/464,984

(22) Filed: Aug. 16, 2006

(51) Int. Cl. G06F 7/00

(52) U.S. Cl. 715/739; 707/7

(57) ABSTRACT

A system and a method for sorting two or more contacts that employ a display name format and a display name reading to provide an intuitive contact order based on pronunciation of a display name are disclosed. The display name reading includes characters, letters, symbols, numbers, and/or phonetic symbols that indicate pronunciation of the display name. Since the system and the method can sort the two or more contacts by arranging the display name readings, the system and the method can provide an intuitive contact order based on the pronunciation of the display name. When the display name formats are changed, the system and the method can update the display name reading according to the newly selected display name format and sort the contacts by arranging the updated display name readings.

### BACKGROUND

Computer devices, particularly mobile or portable computer devices, have become increasingly popular and prevalent in today's society for communication purposes. Many users utilize a mobile computer device, such as a cell phone, as their primary means of communication and carry such devices with them constantly. Mobile computer devices can include multiple functions such as contact management, cellular phone service, voice over Internet protocol (“VoIP”) phone service, software applications, email access, Internet capabilities, calendar functions, music players and the like.

Users typically utilize contact management functionality to select individuals with whom the users wish to communicate. A list of contacts generally includes contact names, addresses, phone numbers, and e-mail addresses. Contact management functionality also often includes a sorting function that enables contacts to be organized in a particular manner. For instance, by scrolling through the names and telephone numbers on a display, the user can find the telephone number of an individual and, typically, by pressing a button, instruct the computer device to dial the number.

Users may have difficulty in accessing the contact information they desire due to the volume and variety of languages and information that may be contained in the mobile computer device, and thus may become frustrated when they are unable to locate the desired contact information.

### SUMMARY

The disclosed subject matter relates to sorting two or more contacts through employment of a display name format and a display name reading to provide an intuitive contact order based on pronunciation of a display name. The contact includes a display name format, a display name, and a display name reading. The display name format determines content and content order of the display name as well as the display name reading. The display name reading contains characters, letters, symbols, numbers, and/or phonetic symbols that indicate pronunciation of the display name. Since two or more contacts can be sorted by arranging the display name readings that indicate the pronunciation of the display name, an intuitive contact order based on the pronunciation of the display name is provided.

When the display name formats are changed, the display name readings can be updated according to the newly selected display name format. Since two or more contacts can be sorted by arranging the updated display name readings, the resultant sorted contacts reflect changing the display name format.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for sorting contacts.

FIGS. 2-11 illustrate example contacts.

FIG. 12 illustrates example sorted contacts.

FIG. 13 illustrates an example contact.

FIG. 14 illustrates example sorted contacts.

FIGS. 15-17 illustrate an example contact and example sorted contacts.

FIG. 18 illustrates a methodology for sorting contacts.

FIG. 19 illustrates a methodology for sorting contacts.

FIG. 20 is a schematic block diagram illustrating an example suitable operating environment.

FIG. 21 is a schematic block diagram of an example computing environment.

### DETAILED DESCRIPTION

The various aspects of the subject matter described herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. Examples of a component include a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. Examples of computer readable media include magnetic storage devices (e.g., hard disk, floppy disk, magnetic strips . . . ), optical disks (e.g. compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

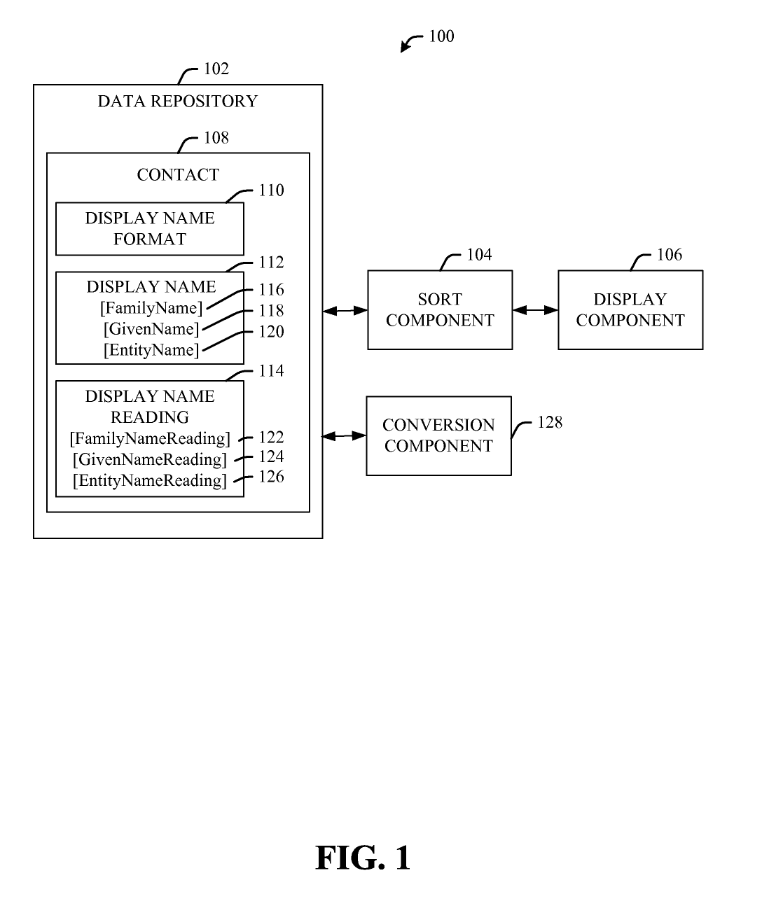

FIG. 1 illustrates a computer-implemented system 100 for sorting contacts. The system 100 includes a data repository 102, a sort component 104, and a display component 106. The system 100 can operate on substantially any type of computing device, including but not limited to a personal computer (PC), portable or notebook computer, pocket PC, PDA, text messenger, cellular phone, smartphone, ultra-mobile tablet PC, and the like.

The data repository 102 includes a plurality of contacts, such as a contact 108. The contact 108 (and other contacts residing within the data repository 102) includes a display name format 110, a display name 112, and a display name reading 114. The display name format 110 determines content and content order of the display name 112 and the display name reading 114 (e.g., whether to display last names (family names) or first names first, whether to display an entity associated with an individual, . . . ). The display name 112 includes at least one of a family name 116, a given name 118, and an entity name 120 according to the display name format 110. Display names are illustrated by way of examples below. The display name reading 114 is a pronunciation of the display name, and includes at least one of a family name reading 122, a given name reading 124, and an entity name reading 126 (that correspond to the family name 116, the given name 118, and/or the entity name 120) according to the display name format 110. Since the name readings 122, 124, 126 contain characters, letters, symbols, numbers, and/or phonetic symbols that indicate pronunciation of the names 116, 118, 120, the display name reading 114 indicates pronunciation of the display name 112. The sort component 104 can sort the two or more contacts 108 by arranging the display name readings 114, thereby providing an intuitive contact order based on the pronunciation of the display name 112.

More particularly, the sort component 104 can sort the two or more contacts 108 first by arranging the display name readings 114 and then by arranging the display names 112. First, the two or more contacts 108 can be sorted by arranging the display name readings 114 in an alphabetical order. Second, the two or more contacts 108 may be sorted by arranging the display names 112 in an alphabetical order. In an example, when two or more contacts include similar display name readings 114, the sort component 104 can sort the two or more contacts 108 by arranging the display names 112. In another example, when two or more contacts contain no letters, characters, and/or phonetic symbols (e.g. no values), the sort component 104 can sort the two or more contacts by arranging the display names 112. The display component 106 can then display the display names 112 of the sorted contacts. For instance, the display component 106 can be associated with cathode-ray tubes (CRT), liquid crystal displays (LCD), and the like.

As stated above, the contact 108 can include the display name format 110, the display name 112, the display name reading 114, the names 116, 11 8, 120, and/or the name readings 122, 124, 126 in corresponding fields, respectively. For example, the contact 108 can contain the display name format 110 in a display name format field, the display name 112 in a display name field, and the display name reading 114 in a display name reading field. The contact 108 can also include the family name 116 in a family name field, the given name 118 in a given name field, and the entity name 120 in an entity name field. The contact 108 can additionally include the family name reading 122 in a family name reading field, the given name reading 124 in a given name reading field, and the entity name reading 126 in an entity name reading field.

The system 100 can employ substantially any language letters, characters, numbers, or symbols, and/or substantially any phonetic symbols (e.g. phonetic alphabets and pronunciation symbols). For instance, the system 100 can employ substantially any letters, characters, symbols, numbers, and phonetic symbols as long as the computer device on which the system operates can recognize the letters, characters, symbols, numbers, and phonetic symbols.

Examples of languages that can be utilized in connection with the system 100 include Afrikaans, Albanian, Algerian Dardja, Amharic, Anishinaabe, Arabic, Armenian, Avestan, Azerbaijani, Balinese, Bashkir, Basque, Belarusan, Bengali, Bisayan, Brahui, Breton, Buhi Bicol, Bulgarian, Burmese, Catalan, Cebuano, Chechen, Cherokee-Tsalagi, Cheyenne, Chinese, Czech, Danish, Dutch, English, Esperanto, Estonian, Etruscan, Farsi, Finnish, French, Frisian, Gaelic, Galician, German, Gilbertese, Greek, Guarani, Hakka, Hawaiian, Hebrew, Hindi, Hmong, Hungarian, Icelandic, Igbo, Indonesian, Ingush, Inuktitut, Italian, Japanese, Kamilaroi, Kapampangan, Kendo, Khowar, Korean, Kurdish, Kyrgyz, Lakhota, Latin, Latvian, Lithuanian, Malay, Maltese, Maori, Mapudungun, Marathi, Mayan, Mayangna, Miskitu, Mohawk, Mongolian, Nauruan, Norwegian, Occitan, Ojibwe, Oriya, Pahlavi, Pali, Panamahka, Pashto, Passamaquoddy-Maliseet, Piraha, Polish, Portuguese, Potawatomi, Prussian, Punjabi, Rasta Patois, Romanian, Romany, Russian, Sami, Sanskrit, Sardinian, Serbo-Croatian, Sioux, Slovak, Slovene, Somali, Sorbian, Spanish, Sranan, Sudovian, Sumerian, Swabian, Swahili, Swedish, Tagalog, Taino, Taiwanese, Tamil, Tarahumara, Tatar, Thai, Tibetan, Tok Pisin, Tongan, Tsalagi, Turkish, Turkmen, Ukrainian, Ulwa, Urdu, Uyghur, Uzbek, Vietnamese, Visayan, Votic, Warlpiri, Welsh, Wolof, Xhosa, Yiddish, Yotvingian, amongst others.

A phonetic symbol is a type of phonetic notation used for transcribing the sounds of human speech into writing. Examples of the phonetic symbol include Americanist phonetic notation such as Americanist Phonetic Alphabet, American Phonetic Alphabet, North American Phonetic Alphabet; the International Phonetic Alphabet (IPA) such as the Speech Assessment Methods Phonetic Alphabet (SAMPA), the Extended SAM Phonetic Alphabet (X-SAMPA), and Kirshenbaum, sometimes called ASCII-IPA, and the like.

The names 116, 118, 120 and the name readings 122, 124, 126 can include substantially any language letters, characters, numbers, or symbols, and/or substantially any phonetic symbols, as described above. In an example, at least one of the family name 116, the given name 118, and the entity name 120 can include an ideographic character. Examples of the ideographic character comprise a Japanese ideographic character (e.g., kanji), a Chinese ideographic character (e.g., hanzi), and a Korean ideographic character (e.g., hanja). For example, the contact 108 may comprise a Japanese kanji family name 116, a Japanese kanji given name 118, and a Japanese kanji entity name 120 (where kanji is a Japanese ideographic character). In another example, the name readings 122, 124, 126 can include at least one of katakana, hiragana, and the Latin alphabet.

The entity name 120 can include a company name, wherein such name can refer to any single individual or group of individuals whether formal or informal. For example, the entity name 120 can include a natural person name, corporation name, association name, firm name, government name, group name, organization name, and the like.

The name readings 122, 124, 126 can include characters, letters, symbols, numbers, and/or phonetic symbol to indicate pronunciation of the names 116, 118, and/or 120. In an example, when the names 116, 118, 120 contain a Japanese character, letter, number, and/or symbol including kana and/or kanji, the name readings 122, 124, 126 may include kana such as katakana and hiragana (sometimes called a Japanese phonetic alphabet) to indicate pronunciation of the names 116, 118, and/or 120. In another example, when the names 116, 118, and/or 120 contain a Korean character, letter, number, and/or symbol (including hanja), the name readings 122, 124, and/or 126 may comprise hangul (sometimes called a Korean alphabet) to indicate pronunciation of the names 116, 118, and/or 120. In yet another example, when the names 116, 118, 120 contain a Chinese character, letter, number, and/or symbol, the name readings 122, 124, 126 may include Chinese pinyin (a system of romanization (phonemic notation and transcription to Roman script) for Standard Mandarin) to indicate pronunciation of the names 116, 118, 120. In still yet another example, when the names 116, 118, 120 include a Russian character, letter, number, and/or symbol, the name readings 122, 124, 126 may comprise Latin alphabet and/or SAMPA to indicate pronunciation of the names 116, 118, 120. Names containing other language characters, letters, numbers, and/or symbols are not described in order to avoid prolixity.

The contact 108 may include substantially any suitable information associated with the person and/or entity of the contact 108. For example, the contact 108 may include a name prefix (Mr., Dr., and the like), name suffix (Jr., Sr., II, and the like), and the like. The contact 108 may also include a department, a job title, an entity's phone number, an entity's FAX number, an entity's address, an IM address, an E-mail address, a mobile phone number, setting of ring alert, a memo, etc. The contact 108 may further contain a person's phone number, a person's FAX number, a person's address, current and/or previous employment data such as current employer name, title, responsibilities, employer's address, employer's phone number, employer's email address, employer's Web site URL, educational data such as degrees, schools, concentration, graduation date; accreditation such as CPA, RN, LCSW, entity description such as entity subsidiaries, entity partners, entity competitors, number of employees, etc.

Additionally, the contact 108 may include contact information in a corresponding field. For example, the contact 108 contains the phone number in a phone number field, the FAX number in a FAX number field, the email address in an email address field, the address in an address field, and the like.

The display name format 110 determines content and content order of the display name 112. Since the display name 112 contains at least one of the family name 116, the given name 118, and the entity name 120, the display name format 110 determines which names the display name 112 includes and in what order the display name 112 includes the names. For example, the display name format 110 can determine the content and content order of the display name 112 in the following manner:

an entity name;

a given name;

a family name;

a given name and a family name (in this order);

a family name and a given name (in this order);

a given name, a family name, and an entity name (in this order);

a family name, a given name, and an entity name (in this order);

an entity name, a given name, and a family name (in this order);

an entity name, a family name, and a given name in this order; etc. The display name format 110 also determines content and content order of the display name reading 114 in a manner similar to that discussed below.

The display name format 110 can include a delimiter. Examples of the delimiter comprise a bracket, parenthesis, comma, semi-colon, and blank space. For example, the display name format 110 can include the following format that comprises at least one delimiter:

[GivenName]<space>[FamilyName];

[GivenName],<space>[FamilyName];

[FamilyName]<space>[GivenName];

[GivenName]<space>[FamilyName]<space>([EntityName]);

[GivenName],<space>[FamilyName]<space>([EntityName]);

[FamilyName]<space>[GivenName]<space>([EntityName]);

[EntityName]<space>([GivenName]<space>[FamilyName]);

[EntityName]<space>([GivenName],<space>[FamilyName]);

[EntityName]<space>([FamilyName]<space>[GivenName]);

[GivenName][FamilyName]<space>([EntityName]);

[FamilyName][GivenName]<space>([EntityName]);

[EntityName]<space>([GivenName][FamilyName]);

[EntityName]<space>([FamilyName][GivenName]); and the like.

The display name 112 can indicate the subject of the contact 108 since the display name 112 includes at least one of the family name 116, the given name 118, and the entity name 120. In an example, the display name 112 contains one text string containing at least one of the family name 116, the given name 118, and the entity name 120.

The display name reading 114 can indicate pronunciation of the display name 112 since the display name reading 114 includes at least one of the family name reading 122, the given name reading 124, and the entity name reading 126. In an example, the display name reading 114 comprises one text string including at least one of the family name reading 122, the given name reading 124, and the entity name reading 126. The name readings 122, 124, 126 can include substantially any language letters, characters, numbers, or symbols, and/or substantially any phonetic symbols as described above to indicate pronunciation of the names 116, 118, 120.

The display name 112 includes at least one of the family name 116, the given name 118, and the entity name 120 according to the display name format 110. The display name reading 114 includes at least one of the family name reading 122, the given name reading 124, and the entity name reading 126 according to the display name format 110. That is, the display name format 110 determines content and content order of the display name 112 as well as the display name reading 114. Table 1 illustrates that example display name formats 110 specify the content and content order of the display name 112 as well as the display name reading 114.

TABLE 1

| | |
|---|---|
| Display name format | Display name |
| | Display name reading |
| [EntityName] | EntityName |
| | EntityNameReading |
| [GivenName]<space>[FamilyName] | GivenName FamilyName |
| | GivenNameReading |
| | FamilyNameReading |
| [GivenName],<space>[FamilyName] | GivenName, FamilyName |
| | GivenNameReading, |
| | FamilyNameReading |
| [FamilyName]<space>[GivenName] | FamilyName GivenName |
| | FamilyNameReading |
| | GivenNameReading |
| [GivenName]<space>[FamilyName]<space> | GivenName FamilyName |
| ([EntityName]) | (EntityName) |
| | GivenNameReading |
| | FamilyNameReading |
| | (EntityNameReading) |
| [GivenName],<space>[FamilyName]<space | GivenName, FamilyName |
| >([EntityName]) | (EntityName) |
| | GivenNameReading, |
| | FamilyNameReading |
| | (EntityNameReading) |
| [FamilyName]<space>[GivenName]<space> | FamilyName GivenName |
| ([EntityName]) | (EntityName) |
| | FamilyNameReading |
| | GivenNameReading |
| | (EntityNameReading) |
| [EntityName]<space>([GivenName]<space> | EntityName (GivenName |
| [FamilyName]) | FamilyName) |
| | EntityNameReading |
| | (GivenNameReading |
| | FamilyNameReading) |
| [EntityName]<space>([GivenName],<space> | EntityName (GivenName, |
| [FamilyName]) | FamilyName) |
| | EntityNameReading |
| | (GivenNameReading, |
| | FamilyNameReading) |
| [EntityName]<space>([FamilyName]<space | EntityName (FamilyName |
| >[GivenName]) | GivenName) |
| | EntityNameReading |
| | (FamilyNameReading |
| | GivenNameReading) |
| [FamilyName][GivenName] | FamilyNameGivenName |
| | FamilyNameReadingGiven |
| | NameReading |
| [GivenName][FamilyName]<space>([Entity | GivenNameFamilyName |
| Name]) | (EntityName) |
| | GivenNameReadingFamily |
| | NameReading |
| | (EntityNameReading) |
| [FamilyName][GivenName]<space>([Entity | FamilyNameGivenName |
| Name]) | (EntityName) |
| | FamilyNameReadingGiven |
| | NameReading |
| | (EntityNameReading) |
| [EntityName]<space>([GivenName][Family | EntityName (GivenName |
| Name]) | FamilyName) |
| | EntityNameReading |
| | (GivenNameReadingFamily |
| | NameReading) |
| [EntityName]<space>([FamilyName][Given | EntityName |
| Name]) | (FamilyNameGivenName) |
| | EntityNameReading |
| | (FamilyNameReadingGiven |
| | NameReading) |

In an example, the display name format 110 is common to all of the contacts 108 in the data repository 102. In other words, all of the display names 112 and the display name readings 114 in the data repository 102 include a substantially similar display name format 110. In another example, the display name format 110 is common to two or more contacts, and other contacts can have different display name formats 110. In yet another example, the display name format 110 is independently defined with respect to each contact.

The content of the contacts such as names 116, 118, 120 and name readings 122, 124, 126 can be provided to the data repository 102 using substantially any suitable methods or tools. In an example, users can provide the content of the contacts by importing the content from a memory of other system or computer into the contacts. In another example, users can provide the content of the contacts by providing characters, letters, numbers, and/or symbols using substantially any suitable input component (not shown). Examples of the input component include a voice command, screen tap, mouse click, keyboard stroke, keypad, joystick, and the like.

The input component may be associated with a commercially available software program product or operating system component such as an Input Method Editor or system (“IME”) for example to facilitate providing contact information such as names 116, 118, 120 and name readings 122, 124, 126. Examples of software programs or operating system components for facilitating providing contact information include a Front End Processor (“FEP”), an Input Method, XIM, and the like. In an example, when providing an ideographic character to the contact 108, the input component typically contains the IME to facilitate Latin alphabet-ideographic character conversion. For example, when providing an ideographic character such as a Japanese character, the input component typically contains a Japanese IME to facilitate kana and/or kanji-kana conversion using, for example, a standard English or Japanese language keyboard. Since Japanese names typically contain kanji, users may enter Latin alphabets, and then the input component may convert the Latin alphabets to kana and/or kanji using the Japanese IME.

In another example, the names 116, 118, 120 and the name readings 122, 124, 126 are provided independently. For instance, users provide the names 116, 118, 120 and the name readings 122, 124, 126 separately. In still another example, the user input of the names 11 6, 118, 120 can be utilized to provide the name readings 122, 124, 126. For example, when users enter Japanese kana of the family name 116, the kana of family name 116 is utilized to provide the family name reading 122. In yet another example, the name readings 122, 124, 126 can be edited by deleting, adding, and/or changing the content of the name readings 122, 124, 126.

The display name reading 114 can be created and/or updated at substantially any suitable time. For instance, a conversion component 128 can be configured to periodically create and/or update the display name reading at predetermined time intervals. In another embodiment, the conversion component 128 can create and/or update the display name reading 114 upon user request. In yet another example, the display name reading 114 can be created and/or updated by the conversion component 128 when at least one of the family name reading 122, the given name reading 124, and the entity name reading 126 is entered, changed, or deleted. In still yet another example, the display name reading 114 can be updated by the conversion component 128 when the display name format 110 is changed.

As described above, the sort component 104 can sort the two or more contacts 108 by arranging the display name readings 114 and then subsequently arranging the display names 112 (e.g., in alphabetical order). The alphabet may be a standardized set of characters, letters, symbols, and numbers of a certain language, or a standardized set of phonetic symbols (phonetic alphabet). The alphabet can be utilized to determine an order of the characters, letters, symbols, numbers, or phonetic symbols.

In another example, when display name readings 114 include Japanese kana such as katakana and hiragana, two or more contacts are sorted by arranging the display name readings 114 and then by arranging the display names 112 in an alphabetical order of kana (e.g., Japanese kana syllabary). In another example, when display name readings 114 include Japanese kana such as katakana and hiragana and Latin alphabet, the two or more contacts are sorted by arranging the display name readings 114 then by arranging the display names 112 in an order of Japanese kana syllabary and Latin alphabet. The Japanese kana syllabary typically contains 46 syllables, including 45 combinations of five vowels (“A,” “I,” “U,” “E,” and “O”) and nine consonants (“K,” “S,” “T,” “N,” “H,” “M,” “Y” “R,” and “W”) and one independent character (“N”). The Japanese syllabary typically contains “A,” “I,” “U,” “E,” “O,” “KA,” “KI,” “KU,” “KE,” “KO,” “SA,” “SHI,” “SU,” “SE,” “SO,” “TA,” “CHI,” “TSU,” “TE” “TO,” “NA,” “NI,” “NU,” “NE,” “NO,” “HA,” “HI,” “FU,” “HE,” “HO,” “MA,” “MI,” “MU,” “ME,” “MO,” “YA,” “YU,” “YO,” “RA,” “RI,” “RU,” “RE,” “RO,” “WA,” “WI,” “WE,” “WO,” and “N” in this order. A contact containing a display name reading 114 beginning with letter “A” is typically placed on the top of a contact list. A contact containing a display name reading 114 beginning with letter “N” is typically placed on the bottom of the contact list.

In an example, the sort component 104 can employ substantially any suitable encoding system or tool to sort the display name readings 114. For example, when the display name reading 114 contains Japanese characters, letters, numbers, and/or symbols, the encoding system or tool may include Unicode, Japanese Industrial Standards (JIS) code, and the like. Characters of readings can be encoded using Unicode. For example, Unicode values U+3040 through U+309F can be assigned to “A” through “N” in hiragana. Unicode values U+30A0 through U+30FF can be assigned to “A” through “N” in katakana. The display name readings 114 can be sorted in an order of the Unicode values of the display name readings 114.

In still another example, when display name readings 114 include Korean hangul, two or more contacts can be sorted by arranging the display name readings 114 then by arranging the display names 112 in an alphabetical order of Korean hangul. In yet another example, when display name readings 114 include Chinese pinyin, the two or more contacts can be sorted by arranging the display name readings 114 and subsequently arranging the display names 112 in a Latin alphabetical order. In still yet another example, when display name readings 114 contain Latin alphabet and/or SAMPA, two or more contacts can be sorted by arranging the display name readings 114 then by arranging the display names 112 in a Latin alphabetical order and/or SAMPA. Sorting two or more contacts in which the display name readings 114 contains other letters, characters, numbers, symbols, and/or phonetic symbols is not described in order to avoid prolixity.

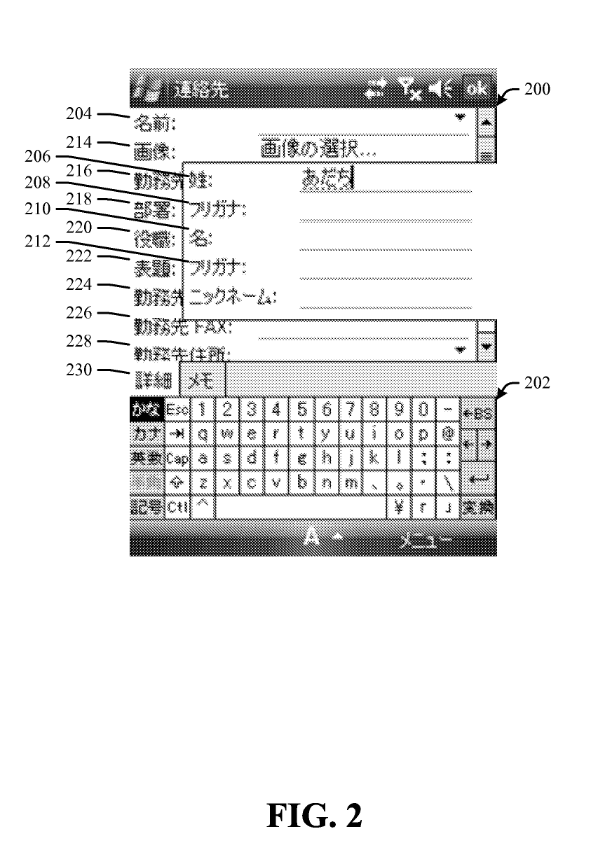

FIGS. 2 to 14 and FIGS. 15 to 17 illustrate two examples of sorting contacts. FIG. 2 illustrates a contact 200 and a software keyboard 202. In this example, the contact includes a name field 204, a family name field 206, a family name reading field 208, a given name field 210, a given name reading field 212, an image field 214, an entity name filed 216, a department field 218, a job title field 220, a display name field 222, an entity's phone number field 224, an entity's FAX number field 226, an entity's address field 228, and a memo field 230. For instance, users can provide contact information by tapping the software keyboard 202 with a stylus or other suitable mechanism.

In this example, the names contain Japanese names, which are typically written in kanji. Because there are many possible readings for kanji names, including special name-only readings called nanori, readings in kana such as katakana and hiragana can be utilized to give the pronunciation of names. The name reading may include at least one of katakana, hiragana, and Latin alphabet.

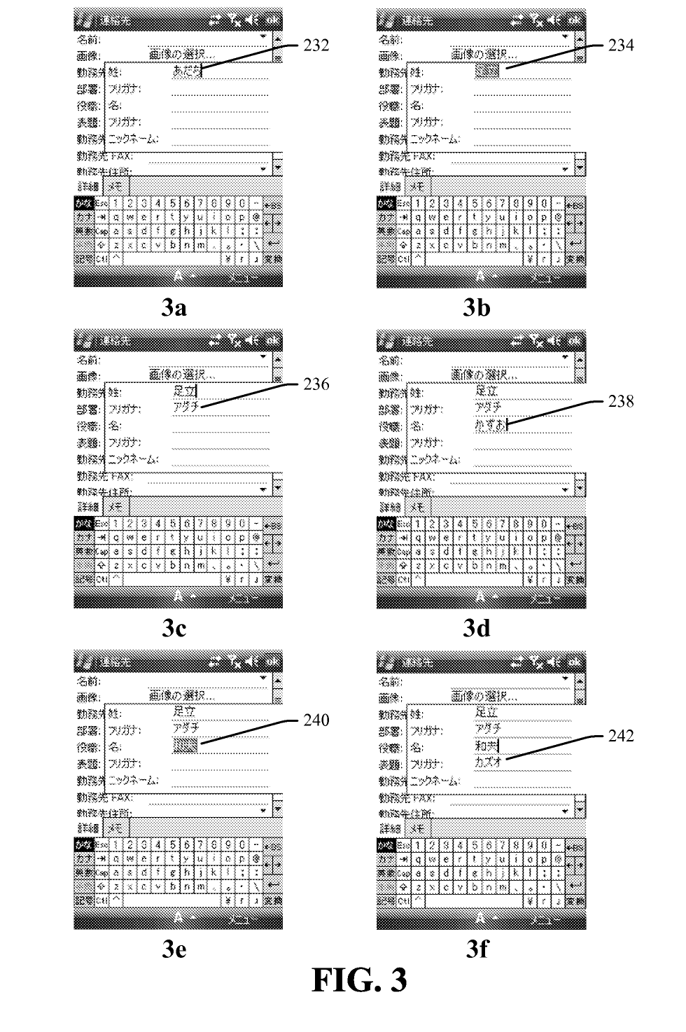

FIG. 3 illustrates the provision of a family name, a family name reading, a given name, and a given name reading. FIG. 3a shows providing hiragana characters of a Japanese family name 232 in the family name field 206 in the contact 200 by tapping the software keyboard 202. FIG. 3b shows conversion of the hiragana characters of the Japanese family name 232 to kanji characters of a Japanese family name 234. FIG. 3c illustrates provision of katakana characters of a Japanese family name reading 236 in a family name reading field 208 using the user input of the hiragana characters of the Japanese family name 232. FIG. 3d illustrates provision of hiragana characters of a Japanese given name 238 in the given name field 210 in the contact 200 by tapping the software keyboard 202. FIG. 3e shows conversion of the hiragana characters of the Japanese given name 238 to kanji characters of a Japanese given name 240. FIG. 3f illustrates provision of katakana characters of a Japanese given name reading 242 in the given name reading field 212 using the user input of the hiragana characters of the Japanese given name 238.

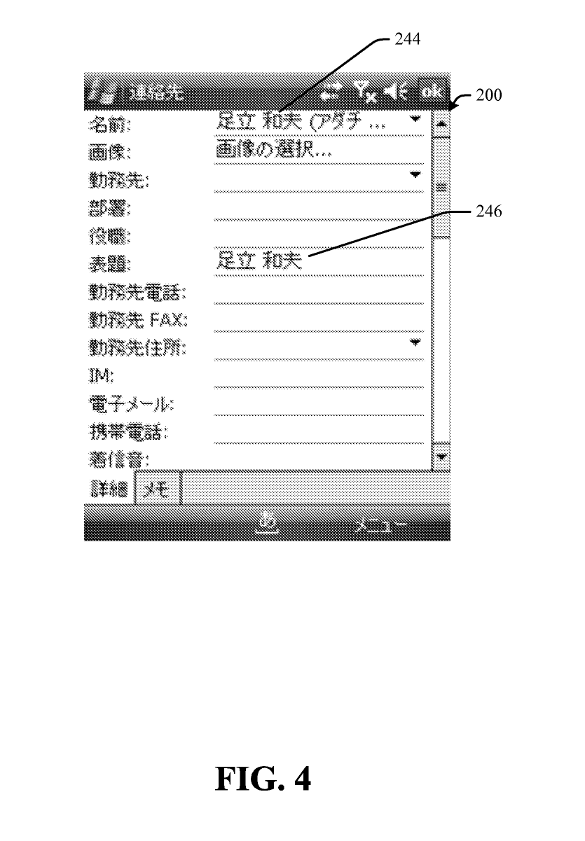

FIG. 4 illustrates the contact 200 after the family name 234, the family name reading 236, the given name 240, and the given name reading 242 have been provided. In this example, a name 244 in the name field 204 includes the family name 234, given name 240, family name reading 236, and given name reading 242. Additionally, a display name 246 in the display name field 222 can contain the family name 234 and given name 240.

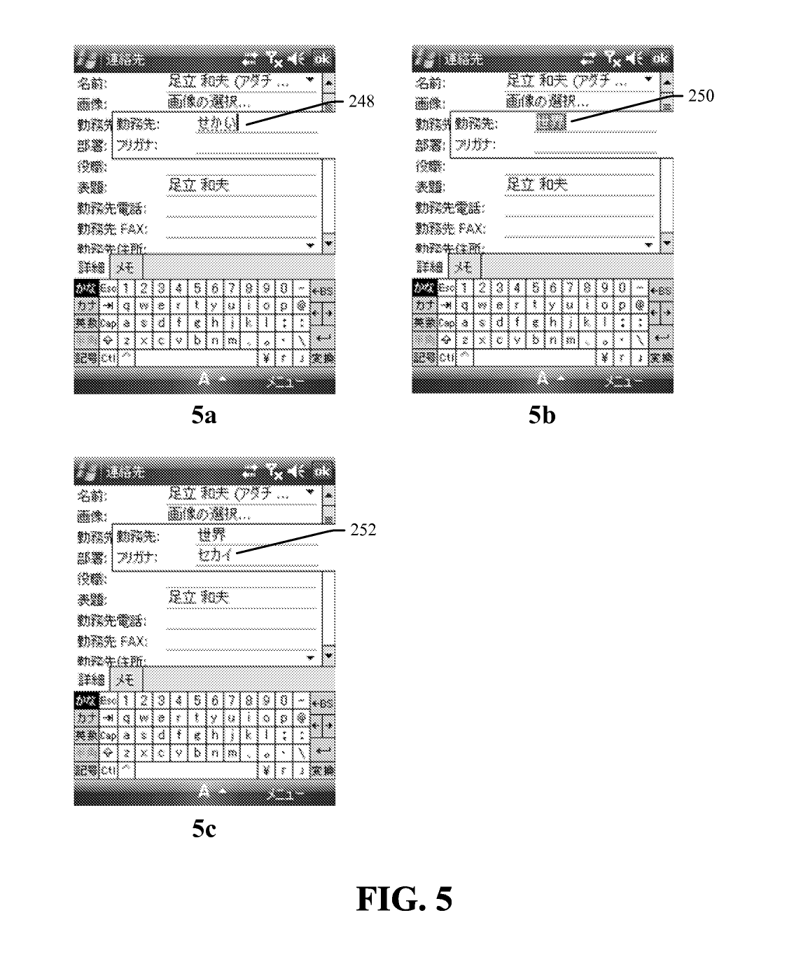

FIG. 5 illustrates provision of an entity name and an entity name reading, wherein a Japanese entity name is utilized. FIG. 5a shows provision of hiragana characters of a Japanese entity name 248 in an entity name field 216 by tapping the software keyboard 202. FIG. 5b illustrates conversion of the hiragana characters of the Japanese entity name 248 to kanji characters of a Japanese entity name 250. FIG. 5c shows katakana characters of a Japanese entity name reading 252 being provided in an entity name reading field using the user input of the hiragana characters of the Japanese entity name 248.

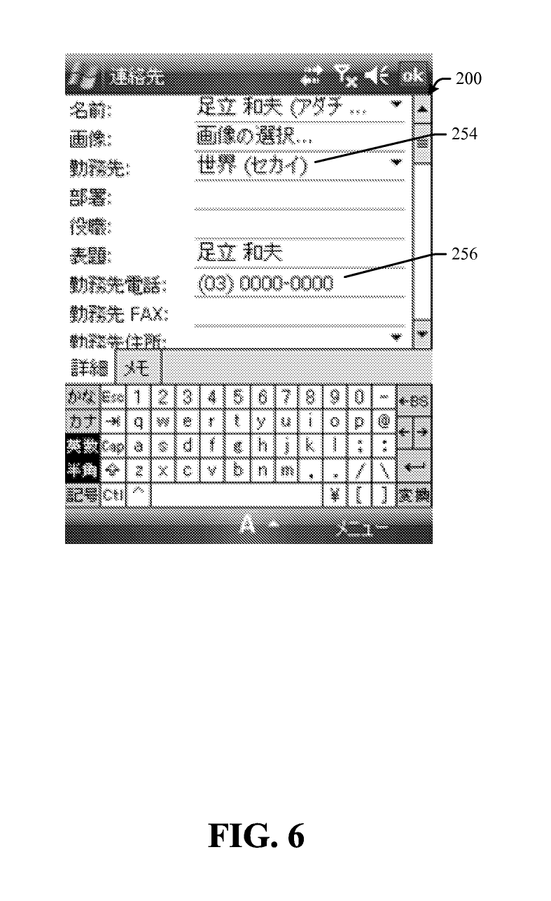

FIG. 6 illustrates the contact 200 after providing an entity name 250 and entity name reading 252. In this example, an entity name 254 in the entity name field contains the entity name 250 and the entity name reading 252. Also, the contact 200 contains an entity phone number 256 in the entity phone number field 224.

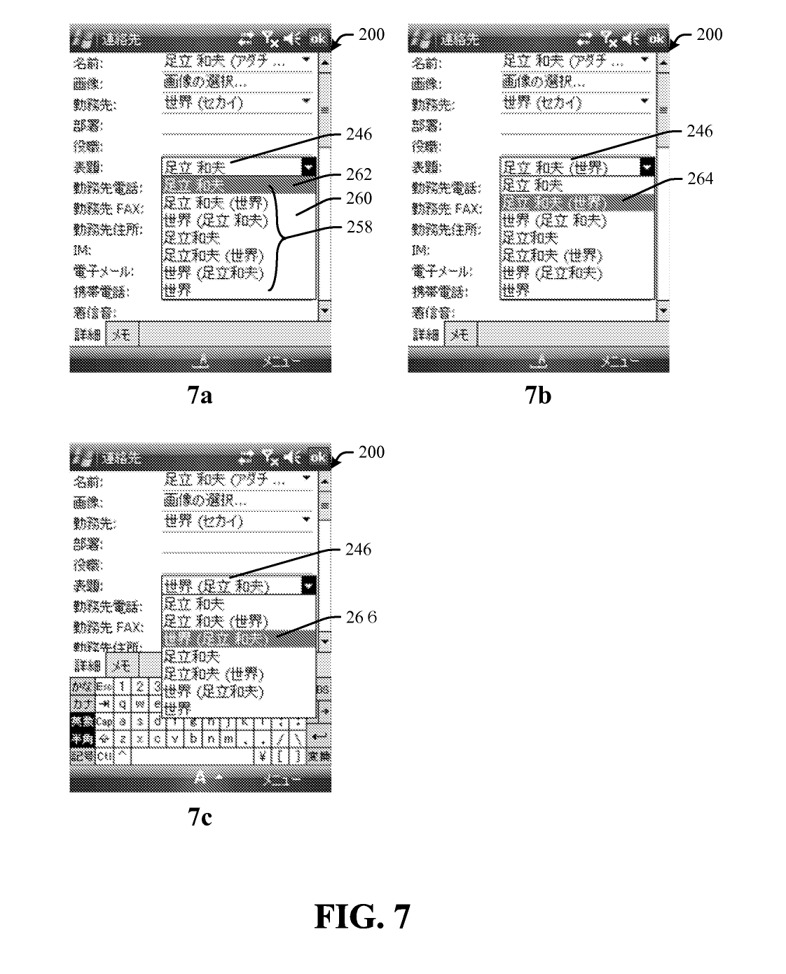

FIG. 7 illustrates the alteration of the display name 246 through selection of a display name format. FIG. 7a illustrates that the contact 200 can be associated with several format options 258 that are available to users on a pull-down menu 260. In this example, the pull-down menu 260 has the following format options 258:

[FamilyName]<space>[GivenName];

[FamilyName]<space>[GivenName]<space>([EntityName]);

[EntityName]<space>([FamilyName]<space>[GivenName]);

[FamilyName][GivenName];

[FamilyName][GivenName]<space>([EntityName]);

[EntityName]<space>([GivenName][FamilyName]); and

[EntityName].

FIG. 7a further illustrates that users select a display name format of [FamilyName]<space>[GivenName] by highlighting that format 262. A display name contains at least one of a family name, a given name, and an entity name according to the display name format. As a result, when the display name format of [FamilyName]<space>[GivenName] is selected, the display name 246 contains [FamilyName]<space>[GivenName] according to a selected display name format 262.

FIGS. 7b and 7c illustrate employing other display name format options. In FIG. 7b, a display name format of [FamilyName]<space>[GivenName]<space>([EntityName]) is selected by highlighting format 264. The display name 246 contains [FamilyName]<space>[GivenName]<space>([EntityName]) according to the selected display name format 264. In FIG. 7c, a display name format of [EntityName]<space>([FamilyName]<space>[GivenName]) is selected by highlighting format 266. The display name 246 contains [EntityName]<space>([FamilyName]<space>[GivenName]) according to the selected display name format 266.

The contact 200 includes a display name reading (not shown). The display name reading contains at least one of the family name reading 236, the given name reading 242, and the entity name reading 252 according to the display name format. As a result, in FIG. 7a, the display name reading contains [FamilyNameReading]<space>[GivenNameReading] according to the display name format 262. In FIG. 7b, the display name reading includes [FamilyNameReading]<space>[GivenNameReading]<space>([EntityNameReading]) according to the display name format 264. In FIG. 7c, the display name reading contains [EntityNameReading]<space>([FamilyNameReading]<space>[GivenNameReading]) according to the display name format 266.

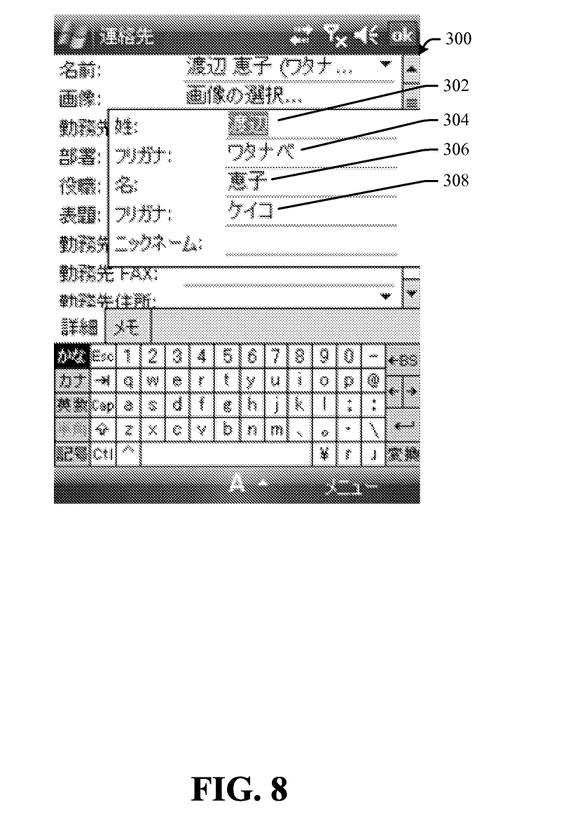

FIG. 8 illustrates another contact 300. In this example, the contact 300 is associated with a Japanese family name 302, a Japanese family name reading 304, a Japanese given name 306, and a Japanese given name reading 308. A display name format (not shown) in this example is associated with [FamilyName]<space>[GivenName]. A display name (not shown) contains [FamilyName]<space>[GivenName] according to the display name format. A display name reading (not shown) contains [FamilyNameReading]<space>[GivenNameReading] according to the display name format. The contact 300 also can include an entity phone number.

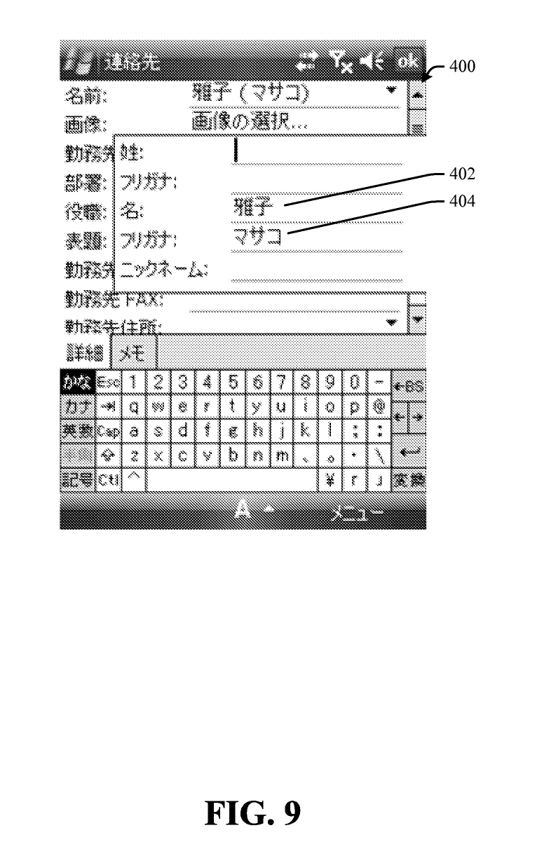

FIG. 9 illustrates yet another contact 400. In this example, the contact includes a Japanese given name 402 and a Japanese given name reading 404. A display name format with respect to this example can include at least [GivenName]. A display name can contain at least [GivenName] according to the display name format. A display name reading can comprise [GivenNameReading] according to the display name format. The contact 300 may also be associated with a phone number, email address, etc.

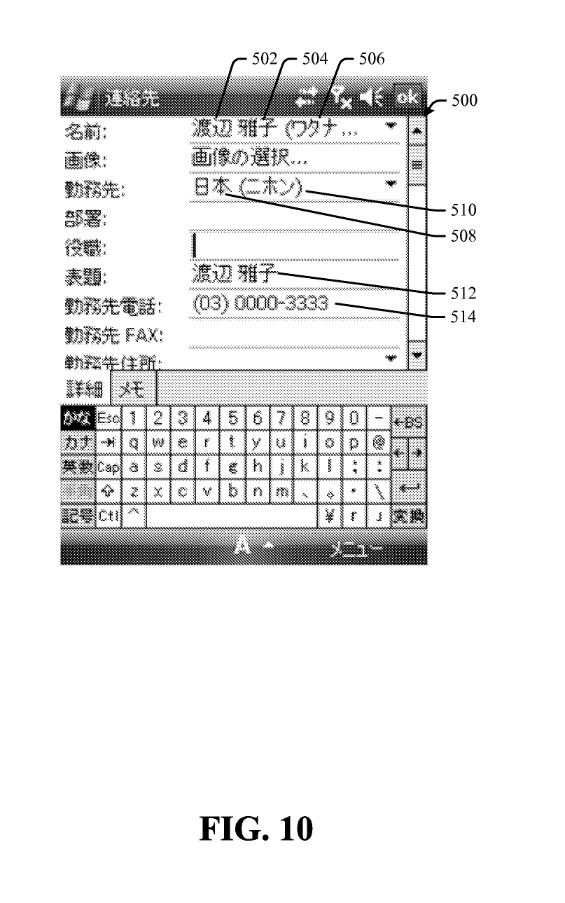

FIG. 10 illustrates still another contact 500. In this example, the contact 500 is associated with a Japanese family name 502, a Japanese given name 504, a Japanese family name reading 506, a Japanese given name reading (not shown), a Japanese entity name 508, and a Japanese entity name reading 510. A display name format with respect to this example can include [FamilyName]<space>[GivenName], but not contain [EntityName]. A display name 512 can include [FamilyName]<space>[GivenName] according to the display name format. A display name reading (not shown) can include [FamilyNameReading]<space>[GivenNameReading] according to the display name format. The contact 300 also can be associated with an entity phone number 514.

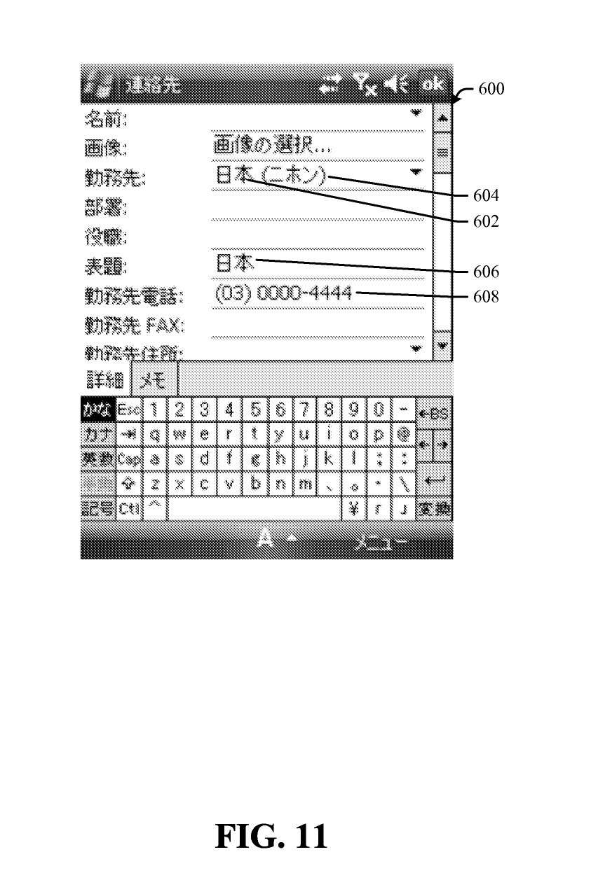

FIG. 11 illustrates still another example contact 600. The contact 600 contains a Japanese entity name 602 and a Japanese entity name reading 604. A display name format, as shown, can include [EntityName], and a display name 606 can comprise [EntityName] according to the display name format. A display name reading contains at least [EntityNameReading] according to the display name format. The contact 600 can also be associated with an entity phone number 608.

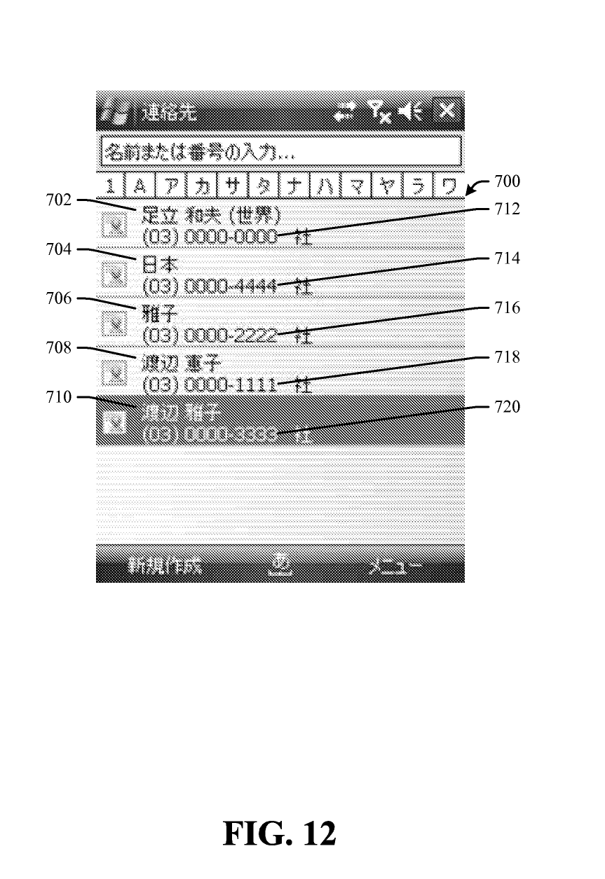

The sort component 104 can sort the five contacts 200, 300, 400, 500, 600 by arranging the display name readings and thereafter by arranging the display names in a Japanese syllabary order (not shown). FIG. 12 illustrates the display names of the resultant sorted contacts (sometimes called a list view) 700. The list view 700 shows the display names from the top to the bottom; 702, 704, 706, 708, 7 10. The list view 700 also shows entity phone numbers of contacts from the top to the bottom; 712, 714, 716, 718, 720. The user may open the contact or make a phone call by selecting the display name.

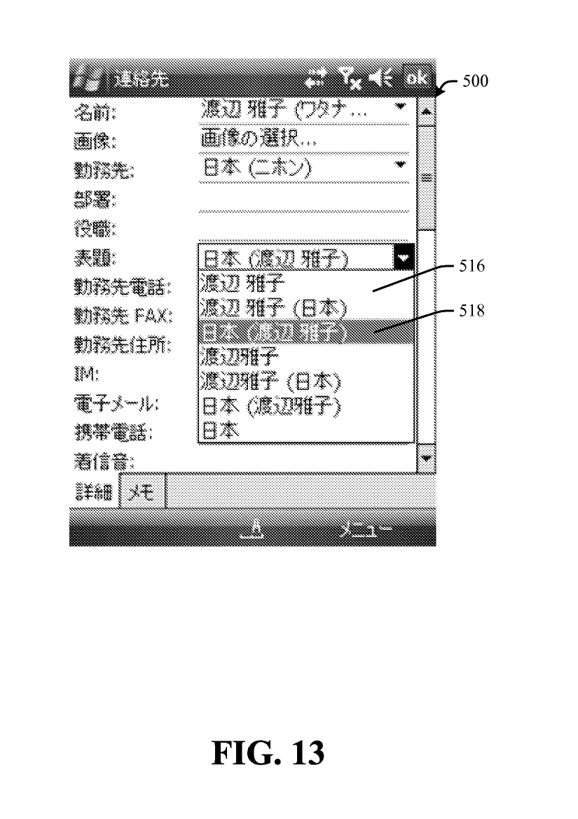

FIG. 13 illustrates alteration of the display name format of the contact 500. For instance, the display name format can be changed by selecting another format using the pull-down menu 516. For example, a display name format of [EntityName]<space>([FamilyName]<space>[GivenName]) can be selected by highlighting the format 518. When a display name format is changed, a display name reading is updated according to the newly selected display name format. Thus, for instance,, when the display name format is changed to [EntityName]<space>([FamilyName]<space>[GivenName]), the display name reading is updated to [EntityNameReading]<space>([FamilyNameReading]<space>[GivenNameReading]) according to the newly selected display name format.

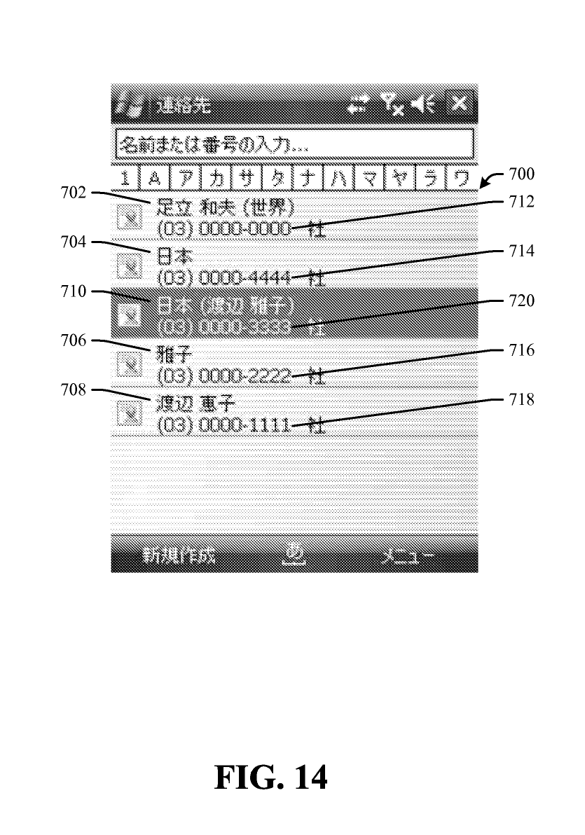

FIG. 14 illustrates the list view 700, wherein display names of sorted contacts are shown after the display name format has been changed in the contact 500 (as shown in FIG. 13). The list view 700 shows the display names from the top to the bottom; 702, 704, 710, 706, 708. The list view 700 also shows phone numbers of contacts from the top to the bottom; 712, 714, 720, 716, 718. The display names of the sorted contacts reflect updating the display name readings compared to the display names of the previous list view 700 in FIG. 12. The sort component 104 can perform updating of the display names after the display name format has been altered.

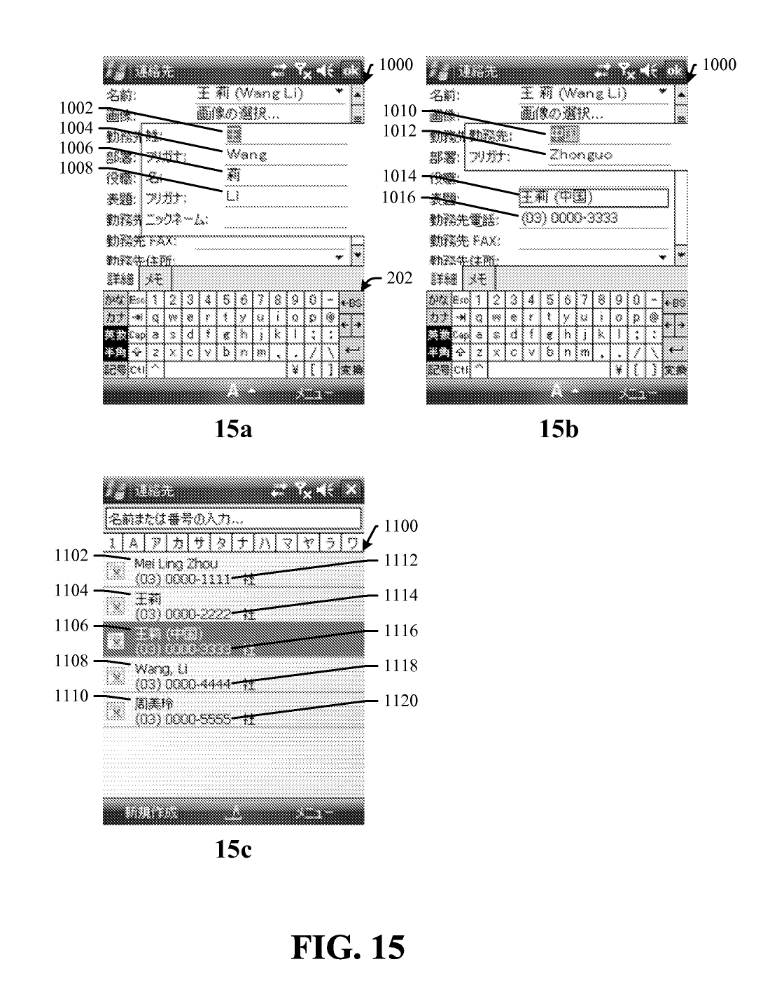

FIG. 15 illustrates a contact 1000 made up of Chinese hanzi names and the software keyboard 202. For instance, name readings contain Chinese pinyin (a system of romanization for Standard Mandarin) to indicate pronunciation of Chinese hanzi names. In FIG. 15a, Chinese hanzi of a Chinese family name 1002, Chinese pinyin of a family name reading 1004, Chinese hanzi of a Chinese given name 1006, and Chinese pinyin of a given name reading 1008 are provided. In FIG. 15b, Chinese hanzi of a Chinese entity name 1010 and Chinese pinyin of an entity name reading 1012 are shown. In FIG. 15b, it is illustrated that the contact can contain a display name format of [FamilyName][GivenName]<space>([EntityName]) (not shown). A display name 1014 can include [FamilyName][GivenName]<space>([EntityName]) according to the display name format. A display name reading (not shown) can comprise [FamilyNameReading][GivenNameReading]<space>([EntityNameReading]) according to the display name format. The contact 1000 also can include an entity phone number 1016.

The sort component 104 can sort several contacts in a logical and intuitive manner by arranging the display name readings and then by arranging the display names in an order of a Latin alphabet (not shown). FIG. 15c illustrates a list view 1100 that shows display names 1102, 1104, 1106, 1108, 1110 of the resultant sorted contacts. The list view 1100 includes the display names from the top to the bottom; 1102, 1104, 1106, 1108, 1110. In this example, the list view 1100 also displays phone numbers of the contacts from the top to the bottom; 1112, 1114, 1116, 1118, 1120. The user may open the contact or make a phone call by selecting the display name.

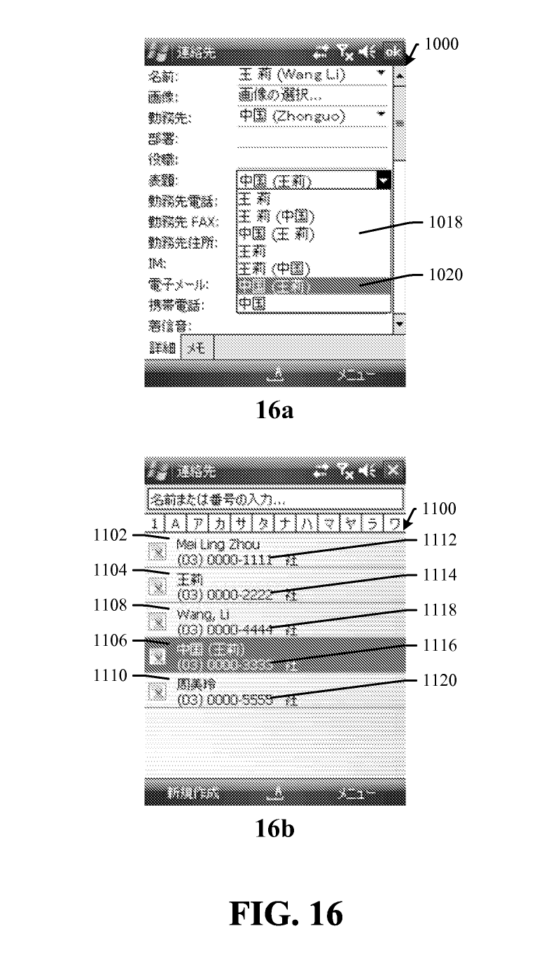

FIG. 16 illustrates an update of the display names of sorted contacts through alteration of the display name format. FIG. 16a illustrates that the display name format of one contact 1000 can be altered. In this example, the display name format can be changed by selecting another format using the pull-down menu 1018. For instance, a display name format of [EntityName]<space>([FamilyName][GivenName]) can be selected by highlighting/selecting format 1020. When a display name format is changed, a display name reading is updated according to the newly selected display name format. For example, when the display name format is changed to [EntityName]<space>([FamilyName][GivenName]), the display name reading can be updated to [EntityNameReading]<space>([FamilyNameReading][GivenNameReading]) according to the newly selected display name format.

FIG. 16b illustrates the display names of the sorted contacts in the list view 1100 after changing the display name format in the contact 1000. The list view 1100 shows the display names from the top to the bottom; 1102, 1104, 1108, 1106, 1110. In this example, the list view 1100 also shows phone numbers of the contacts from the top to the bottom; 1112, 1114, 1118, 1116, 1120. The display names of the sorted contacts reflect update of the display name readings compared to the display names of the previous list view 1100 in FIG. 15c. As described above, the sort component 104 can perform such updating.

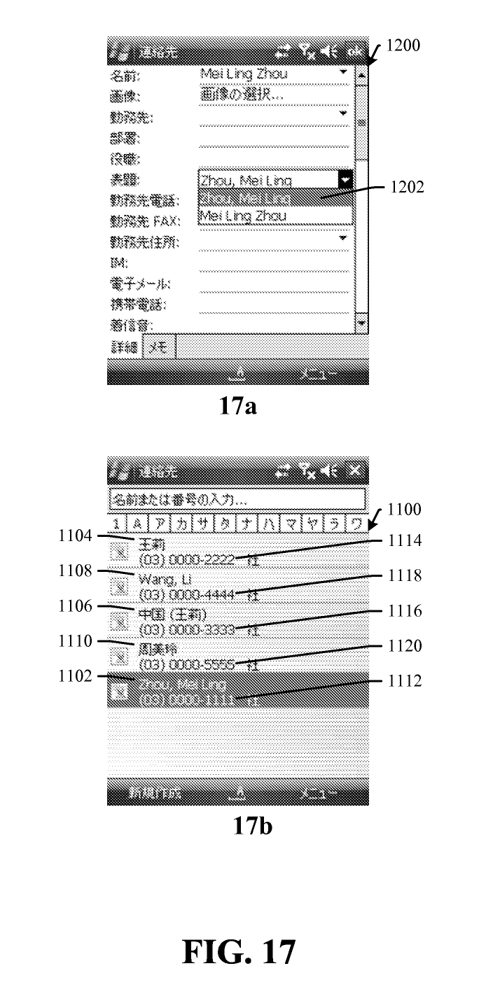

FIG. 17 illustrates another example of updating the display names of sorted contacts through alteration of the display name format. FIG. 17a illustrates change of the display name format of a contact 1200. In this example, a display name format of [GivenName],<space>[FamilyName] is selected by highlighting a display name format 1402. When a display name format is changed, a display name reading is updated according to the newly selected display name format. For instance, when the display name format is changed to [GivenName],<space>[FamilyName], the display name reading can be updated to [GivenNameReading],<space>[FamilyNameReading] according to the newly selected display name format.

FIG. 17b illustrates the list view 1100 that shows the display names of the sorted contacts after the display name format in the contact 1400 in FIG. 17a has been changed. The list view 1100 shows the display names from the top to the bottom; 1104, 1108, 1106, 1110, 1102. The list view 1100 also shows phone numbers of the contacts from the top to the bottom; 1114, 1118, 1116, 1120, 1112. The display names of the sorted contacts reflect updating the display name readings compared to the display names of the previous list views 1100 in FIGS. 15c and 16b.

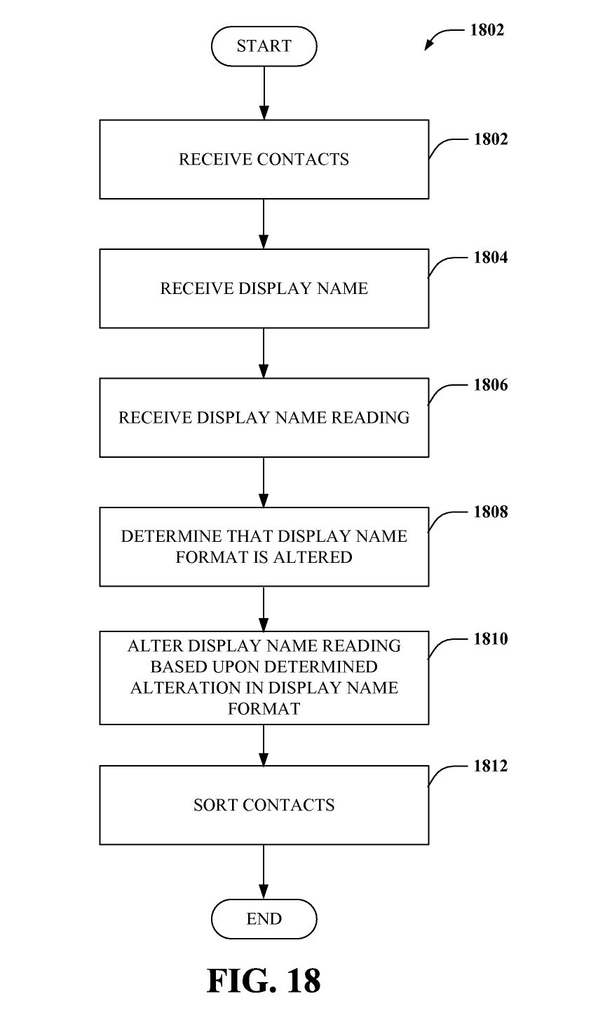

FIG. 18 illustrates a method for sorting contacts. At 1802, two or more contacts are received, wherein each of the two or more contacts includes a display name format. At 1804, a display name is received, wherein the display name includes at least one of a family name, a given name, and an entity name according to the display name format. At 1806, a display name reading is received. The display name reading can include at least one of a family name reading, a given name reading, and an entity name reading according to the display name format. At 1808, a determination is made that the display format has been altered, and at 1810, a change is made regarding the display name reading based upon the determined alteration at 1808 in the display name format. At 1812, the two or more contacts are sorted by arranging the display name readings and thereafter arranging the display names.

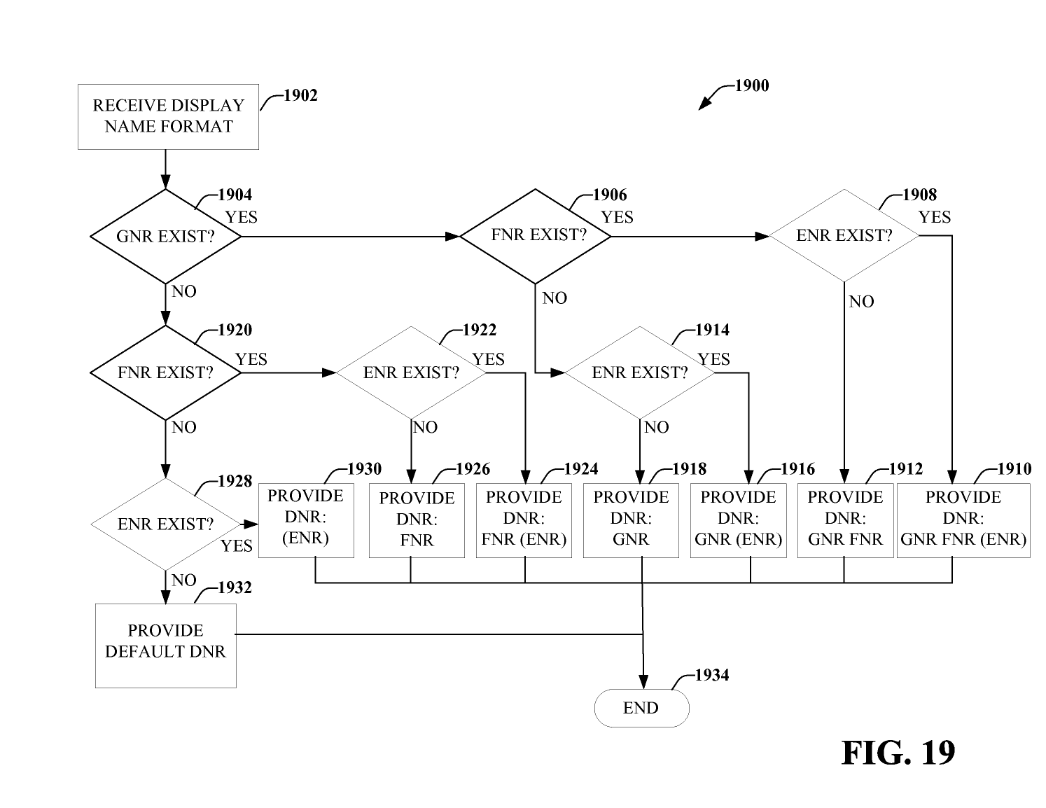

FIG. 19 illustrates a method for sorting contacts. In particular, FIG. 19 illustrates a method 1900 for providing or updating a display name reading in a contact according to a display name format. The display name format is received at 1902. For instance, the display name format can be [GivenName]<space>[FamilyName]<space>([EntityName]). Further, if the contact contains a given name reading, a family name reading, and an entity name reading, a display name reading is associated with [GivenNameReading]<space>[FamilyNameReading]<space>([EntityNameReading]) according to the display name format. In FIG. 19, “DNR,” “GNR, ” “FNR,” and “ENR” represent a display name reading, GivenNameReading, FamilyNameReading, and EntityNameReading, respectively.

At 1904, a determination is made regarding whether a contact is associated with a given name reading. If the contact is associated with a given name reading, at 1906 a determination is made regarding whether the contact is associated with a family name reading. If the contact is associated with a given name reading and a family name reading, then at 1908 a determination is made regarding whether the contact is associated with an entity name reading. If yes, then a display name reading of [GivenNameReading]<space>[FamilyNameReading]<space>([EntityNameReading]) is provided at 1910. If the contact is associated with a given name reading and a family name reading but not an entity name reading, (e.g., the determination at 1908 is “no”), then at 1912 a display name reading of [GivenNameReading]<space>[FamilyNameReading] is provided at 1912.

If it is determined at 1906 that the contact is not associated with a family name reading, at 1914 a determination is made regarding whether the contact is associated with an entity name reading. If it is determined that the contact is associated with an entity name reading, then at 1916 a display name reading of [GivenNameReading]<space>([EntityNameReading]) is provided. If it is determined at 1914 that the contact is not associated with an entity name reading, then a display name reading of [GivenNameReading] can be provided at 1918.

If at 1904 it is determined that the contact is not associated with a given name reading, then at 1920 a determination is made regarding whether the contact is associated with a family name reading. If it is determined that the contact is associated with a family name reading, then at 1922 a determination is made regarding whether the contact is associated with an entity name reading. If the contact is associated with an entity name reading, at 1924 a display name reading of [FamilyNameReading]<space>([EntityNameReading]) can be provided. If it is determined that the contact is not associated with an entity name reading, then at 1926 a display name reading of [FamilyNameReading] can be provided.

If it is determined at 1920 that the contact is not associated with a family name reading, then at 1928 a determination is made regarding whether the contact is associated with an entity name reading. If it is determined that the contact is associated with an entity name reading, then at 1930 a display name reading of ([EntityNameReading]) can be provided at 1930. If at 1928 a determination is made that there is no entity name associated with the contact, then a display name reading of “Unnamed” (or other suitable language) can be provided at 1932. The methodology 1900 then completes at 1934.

It is understood that unnecessary spaces in the display name reading can be removed automatically. For example, if the contact is associated only an entity name reading, a display name reading of ([EntityNameReading]) can be provided by removing spaces from <space><space>([EntityNameReading]). A method for providing or updating a display name in a contact according to a display name format can be performed in a similar manner as described in FIG. 19.

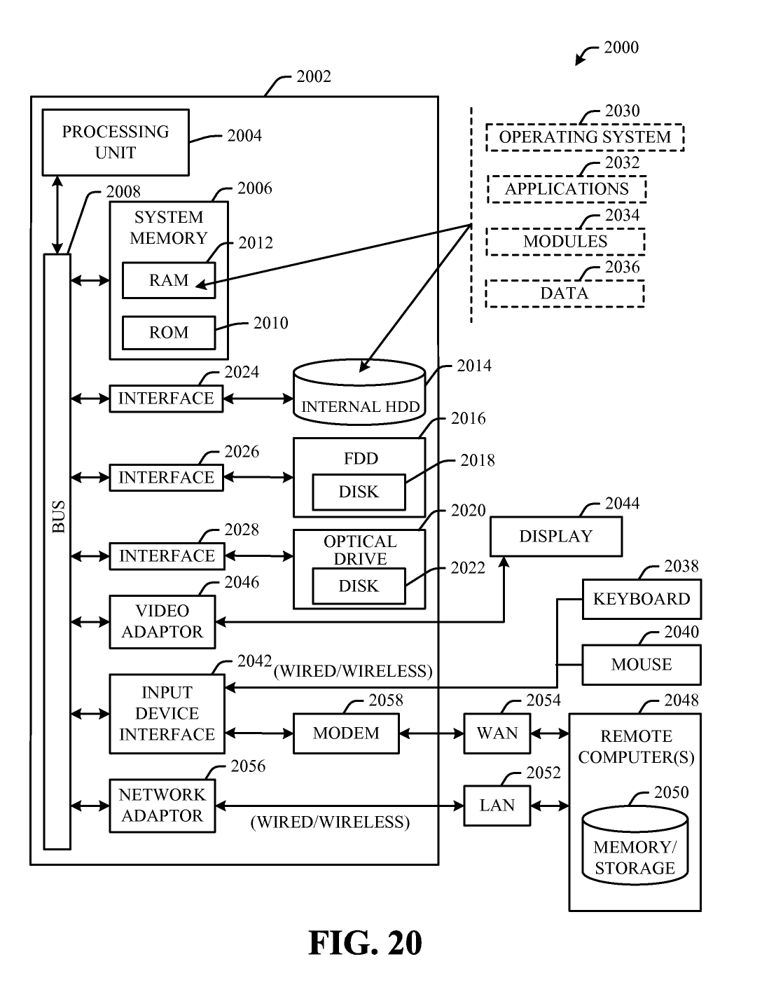

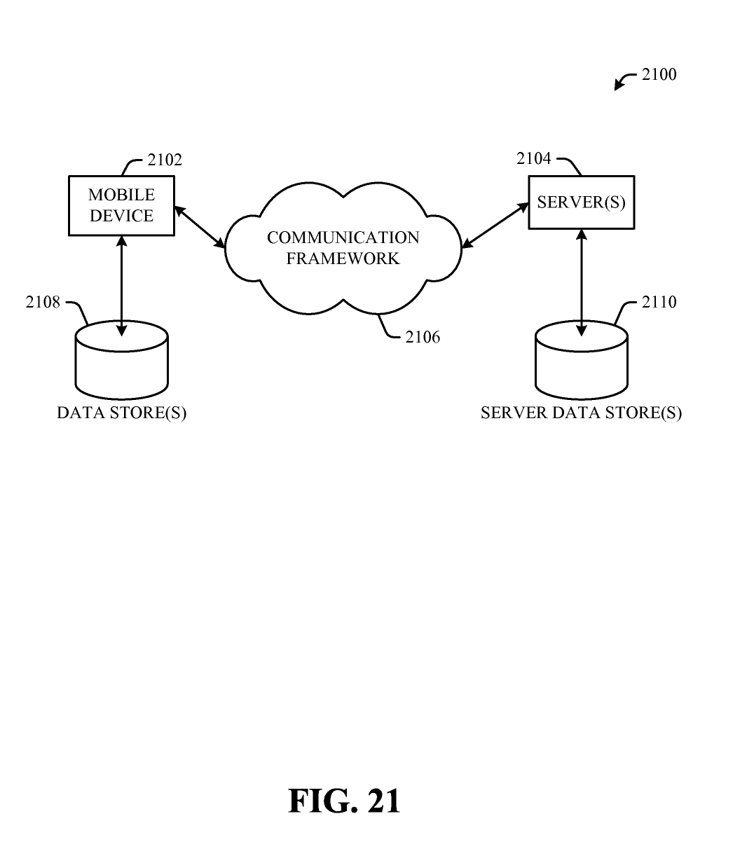

In order to provide a context for the various aspects of the disclosed subject matter, FIGS. 20 and 21 as well as the following discussion are intended to provide a brief, general description of a suitable environment in which the various aspects of the disclosed subject matter may be implemented. While the subject matter has been described above in the general context of computer-executable instructions of a computer program that runs on a mobile device including a computer and/or computers, those skilled in the art will recognize that the innovations described herein also may be implemented in combination with other program modules or software applications. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the subject matter described herein can be practiced on stand-alone computers, including mobile devices. In a distributed computing environment, program modules may be located in both local and remote memory storage devices.

With reference again to FIG. 20, the exemplary environment 2000 for implementing various aspects of the embodiments includes a mobile device or computer 2002, the computer 2002 including a processing unit 2004, a system memory 2006 and a system bus 2008. The system bus 2008 couples system components including the system memory 2006 to the processing unit 2004. The processing unit 2004 can be any of various commercially available processors. Dual microprocessors and other multi-processor architectures may also be employed as the processing unit 2004.

The system memory 2006 includes read-only memory (ROM) 2010 and random access memory (RAM) 2012. A basic input/output system (BIOS) is stored in a non-volatile memory 2010 such as ROM, EPROM, EEPROM, which BIOS contains the basic routines that help to transfer information between elements within the computer 2002, such as during start-up. The RAM 2012 can also include a high-speed RAM such as static RAM for caching data.

The computer or mobile device 2002 further includes an internal hard disk drive (HDD) 2014 (e.g., EIDE, SATA), which internal hard disk drive 2014 may also be configured for external use in a suitable chassis (not shown), a magnetic floppy disk drive (FDD) 2016, (e.g., to read from or write to a removable diskette 2018) and an optical disk drive 2020, (e.g., reading a CD-ROM disk 2022 or, to read from or write to other high capacity optical media such as the DVD). The hard disk drive 2014, magnetic disk drive 2016 and optical disk drive 2020 can be connected to the system bus 2008 by a hard disk drive interface 2024, a magnetic disk drive interface 2026 and an optical drive interface 2028, respectively. The interface 2024 for external drive implementations includes at least one or both of Universal Serial Bus (USB) and IEEE 1394 interface technologies. Other external drive connection technologies are within contemplation of the subject systems and methods.

The drives and their associated computer-readable media provide nonvolatile storage of data, data structures, computer-executable instructions, and so forth. Consequently, the contact sorting instructions can be stored using the drives and their associated computer-readable media. For the computer 2002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the contact management system described herein.

A number of program modules can be stored in the drives and RAM 2012, including an operating system 2030, one or more application programs 2032, other program modules 2034 and program data 2036. The application programs 2032 can provide content for the data repository. All or portions of the operating system, applications, modules, and/or data can also be cached in the RAM 2012. It is appreciated that the systems and methods can be implemented with various commercially available operating systems or combinations of operating systems.

A user can enter commands and information into the computer 2002 through one or more wired/wireless input devices, e.g. a keyboard 2038 and a pointing device, such as a mouse 2040. Other input devices (not shown) may include a microphone, an IR remote control, a joystick, a game pad, a stylus pen, touch screen, or the like. These and other input devices are often connected to the processing unit 2004 through an input device interface 2042 that is coupled to the system bus 2008, but can be connected by other interfaces, such as a parallel port, an IEEE 1394 serial port, a game port, a USB port, an IR interface, etc. A display device 2044 can be used to provide a set of sorted contacts to a user. The display devices can be connected to the system bus 2008 via an interface, such as a video adapter 2046.

The mobile device or computer 2002 may operate in a networked environment using logical connections via wired and/or wireless communications to one or more remote computers, such as a remote computer(s) 2048. For example, the contact sorting instructions can be local to the computer 2002 and software applications can be located remotely on a remote computer 2048. The remote computer(s) 2048 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2050 is illustrated. The logical connections depicted include wired/wireless connectivity to a local area network (LAN) 2052 and/or larger networks, e.g. a wide area network (WAN) 2054. Such LAN and WAN networking environments are commonplace in offices and companies, and facilitate enterprise-wide computer networks, such as intranets, all of which may connect to a global communications network, e.g., the Internet.

When used in a LAN networking environment, the computer 2002 is connected to the local network 2052 through a wired and/or wireless communication network interface or adapter 2056. The adaptor 2056 may facilitate wired or wireless communication to the LAN 2052, which may also include a wireless access point disposed thereon for communicating with the wireless adaptor 2056.

When used in a WAN networking environment, the computer 2002 can include a modem 2058, or is connected to a communications server on the WAN 2054, or has other means for establishing communications over the WAN 2054, such as by way of the Internet. The modem 2058, which can be internal or external and a wired or wireless device, is connected to the system bus 2008 via the serial port interface 2042. In a networked environment, program modules depicted relative to the computer 2002, or portions thereof, can be stored in the remote memory/storage device 2050. It will be appreciated that the network connections shown are exemplary and other means of establishing a communications link between the computers can be used.

The computer 2002 is operable to communicate with any wireless devices or entities operatively disposed in wireless communication, e.g., a printer, scanner, desktop and/or portable computer, PDA, communications satellite, any piece of equipment or location associated with a wirelessly detectable tag (e.g. a kiosk, news stand, restroom), and telephone. The wireless devices or entities include at least Wi-Fi and Bluetooth™ wireless technologies. Thus, the communication can be a predefined structure as with a conventional network or simply an ad hoc communication between at least two devices.

Wi-Fi or Wireless Fidelity allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 21 is a schematic block diagram of a sample environment 2100 with which the systems and methods described herein can interact. The system 2100 includes one or more mobile device(s) 2102. The mobile device(s) 2102 can be hardware and/or software (e.g. threads, processes, computing devices). The system 2100 also includes one or more server(s) 2104. Thus, system 2100 can correspond to a two-tier client server model or a multi-tier model (e.g., client, middle tier server, data server), amongst other models. The server(s) 2104 can also be hardware and/or software (e.g., threads, processes, computing devices). One possible communication between a mobile device 2102 and a server 2104 may be in the form of a data packet adapted to be transmitted between two or more computer processes. The system 2100 includes a communication framework 2106 that can be employed to facilitate communications between the mobile device(s) 2102 and the server(s) 2104. The mobile device(s) 2102 can be operably connected to or include one or more data store(s) 2108 that can be employed to store information local to the mobile device(s) 2102. Similarly, the server(s) 2104 are operably connected to one or more server data store(s) 2110 that can be employed to store information local to the servers 2104.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “including,” “contains,” “containing,” “has,” or “having” are used in either the detailed description or the claims, such terms are intended to be inclusive in a manner similar to the term “comprising” as “comprising” is interpreted when employed as a transitional word in a claim.

What is claimed is:

1. A computer-implemented system for sorting contacts, comprising:
a data repository that comprises two or more contacts, each contact comprising:
a display name format;
a display name comprising at least one of a family name, a given name, and an entity name according to the display name format; and
a display name reading comprising at least one of a family name reading, a given name reading, and an entity name reading according to the display name format; and
a sort component that sorts the two or more contacts by arranging the display name readings of the two or more contacts and thereafter arranging the display names of the two or more contacts, the sort component further updates the display name reading when the display name format is changed.

2. The system of claim 1, at least one of the family name, the given name, and the entity name comprise an ideographic character.

3. The system of claim 2, the ideographic character is at least one of a Japanese ideographic character, a Chinese ideographic character, and a Korean ideographic character.

4. The system of claim 1, the display name format determines content and content order of the display name and the display name reading.

5. The system of claim 1, the display name format comprises at least one of an entity name, a family name, and a given name.

6. The system of claim 5, the display name format further comprises a delimiter.

7. The system of claim 6, the delimiter is one of a bracket, a parenthesis, a comma, a semi-colon, and a blank space.

8. The system of claim, 1 the display name reading is created or updated when at least one of the family name reading, the given name reading, and the entity name reading is entered, changed, or deleted.

9. The system of claim 1, the display name format is independently defined in each contact.

10. The system of claim 1, the display name format is common to two or more of the contacts.

11. The system of claim 1, the sort component sorts the two or more contacts by arranging the display name readings thereafter by arranging the display names alphabetically.

12. The system of claim 1, the contact further comprises at least one of an email address, an address, a phone number, a FAX number, an image, a job title, a department, setting of ring alert, a name prefix, a name suffix, employment data, educational data, and a memo.

13. The system of claim 1 further comprising a display component that displays the display names of the sorted contacts.

14. The system of claim 1, a mobile phone comprises the data repository and the sort component.

15. A method for sorting contacts, comprising:
receiving two or more contacts, wherein each of the two or more contacts includes a display name format;
receiving a display name that comprises at least one of a family name, a given name, and an entity name according to the display name format;
receiving a display name reading that comprises at least one of a family name reading, a given name reading, and an entity name reading according to the display name format;
determining that the display format is altered;
altering the display name reading based upon the determined alteration in the display name format; and
sorting the two or more contacts by arranging the display name readings of the two or more contacts and thereafter arranging the display names of the two or more contacts.

16. The method of claim 15 further comprising updating the display name reading when at least one of the family name reading, the given name reading, and the entity name reading is entered, changed, or deleted.

17. The method of claim 15, further comprising displaying the display names of the sorted contacts.

18. The method of claim 15, at least one of the family name, the given name, and the entity name comprise an ideographic character.

19. A computer-implemented system for sorting two or more contacts, comprising:
means for providing a display name according to a display name format in the contact;
means for providing a display name reading according to the display name format in the contact;
means for modifying the display name reading when the display name format is changed;
means for sorting the two or more contacts by arranging the display name readings and then by arranging the display names; and
means for displaying the display names of the sorted contacts.

20. The computer-implemented system of claim 19, further comprising means for providing the display name format, the display name, and the display name reading.
